(19) United States
(12) Patent Application Publication
(10) Pub. No.: US 2004/0171403 A1
(43) Pub. Date: Sep. 2, 2004

(54) Integrated radio telephone structure

(75) Inventor: Jyrki Mikkola, Kaustinen (FI)

Correspondence Address: DARBY & DARBY P.C., P. O. BOX 5257, NEW YORK, NY, 10150-5257, US

(73) Assignee: Filtronic LK OY, Kempele (FI)

(21) Appl. No.: 10/748,698

(22) Filed: Dec. 29, 2003

Related U.S. Application Data
(63) Continuation of application No. PCT/FI02/00565, filed on Jun. 26, 2002.

(30) Foreign Application Priority Data
Jun. 29, 2001 (FI) 20011400
Dec. 20, 2001 (FI) 20012525

(51) Int. Cl. H04M 7/00

(52) U.S. Cl. 455/550.1; 455/575.1

(57) ABSTRACT

Radio telephone structure where different functions share mechanical parts. The structure employs at least one piezoelectric ceramic element (350, 360) to produce mechanical movement in a component that would be needed in the radio telephone anyway. The mechanical movement generates sound waves or vibration. The moving element may be a plane or part of a plane (311, 312) of a planar antenna. The structure can be applied inverted, in which case the earphone assembly, for example, serves as a microphone. The number of components and/or elements needed in a radio telephone is reduced and the overall space required by the antenna and speaker is reduced.

The invention relates to a radio telephone structure where different functions share mechanical parts.

### BACKGROUND OF THE INVENTION

A common objective in a wide range of technical apparatus is to reduce the number of discrete components, for a smaller number of components means lower manufacturing costs and better reliability. Moreover, it helps reduce the size of a given structure, which is particularly desirable in mobile phones and other portable radio telephones.

One possible way of reducing the number of relatively large components in radio telephones is to integrate the antenna and earphone/speaker of the telephone. In this case the antenna is an internal planar antenna, which in itself is a solution that reduces the size of the telephone. FIG. 1 shows an integrated structure known to the applicant from patent application FI 20011400. The structure comprises a conductive ground plane GND and, parallel therewith, a planar component 100 which emits both radio waves and sound waves. The radiating component 100 is layered. The middle layer 110 is comprised of an EMFi-type (Electromechanical Film) material with a conductive diaphragm in the center. Above the middle layer there is a support layer 105 made of a porous and flexible material permeable to sound, and below the middle layer there is another similar support layer 106. In both support layers, the surface facing the middle layer is corrugated so that the area in contact with the middle layer is relatively small. These corrugated inner surfaces are coated with a conductive material. To the resulting conductive dual plane there is coupled an antenna feed conductor 121 and a short-circuit conductor 122 so that the dual plane serves as a radiating plane for the antenna. In addition, the conductive layers of the inner surfaces of the support layers 105, 106 are coupled to an output of an audio amplifier in the radio telephone via an audio conductor 131. A second audio conductor 132 is coupled to said conductive diaphragm in the middle layer 110. The middle layer is made such that an audio voltage causes it to move either up or down, depending on the direction of the electric field corresponding to the audio voltage in the EMFi material. Thus the component 100 also generates sound waves according to the audio signal.

The radiating component 100 is supported by its edges to the plane below it by a dielectric frame 140 of which only a small portion is visible in FIG. 1. The frame 140 helps form an enclosed or nearly enclosed box which is advantageous as regards sound reproduction. Without it, the radiating component would be acoustically short-circuited, especially at low audio frequencies.

### SUMMARY OF THE INVENTION

An object of the invention is to provide in a novel, more versatile and advantageous manner a radio telephone structure where different functions share mechanical parts. A radio telephone structure according to the invention is characterized in that which is specified in claim 1. The other claims present some advantageous embodiments of the invention.

The basic idea of the invention is as follows: A piezoelectric ceramic element is used to produce mechanical movement in a component of a radio telephone, which component is needed in the telephone in any case. Mechanical movement is used to generate sound waves or vibration. The moving element may be the plane or part of the plane of a planar antenna or part of the shell of the telephone. The structure may also be applied inverted so that e.g. the earphone structure serves as a microphone.

An advantage of the invention is that the number of components and/or elements needed in a radio telephone is reduced. The structure of the radio telephone also becomes simpler as compared with the prior art. Furthermore, the overall space required by the antenna and speaker, for instance, is reduced.

### BRIEF DESCRIPTION OF THE DRAWINGS

The invention is below described in detail. Reference is made to the accompanying drawings in which

FIG. 1 shows an example of integration according to the prior art in a radio telephone,

FIG. 2a shows an example of integration according to the invention in a radio telephone,

FIG. 2b illustrates the operating principle of the structure of FIG. 2a,

FIG. 3 shows a second example of integration according to the invention in a radio telephone,

FIG. 4a shows a third example of integration according to the invention in a radio telephone and

FIG. 4b illustrates the operating principle of the structure of FIG. 4a.

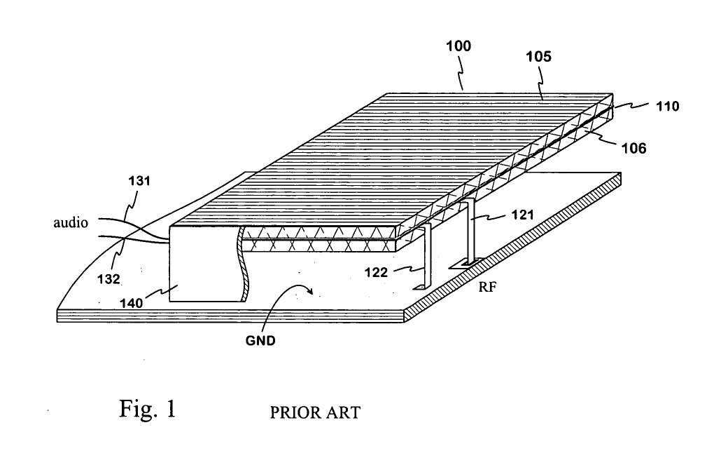

### DETAILED DESCRIPTION OF THE INVENTION

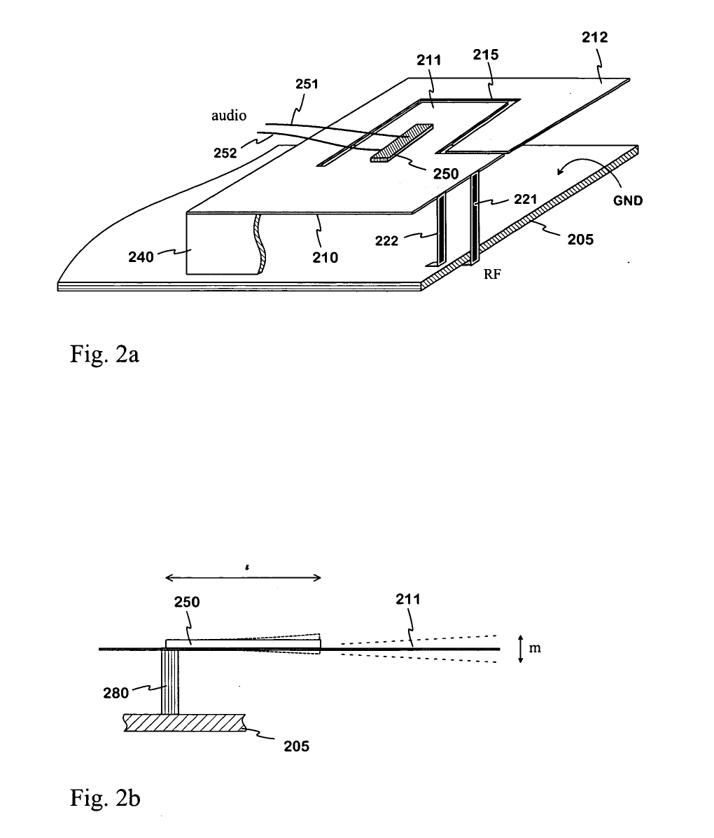

FIG. 2a shows an example of integration according to the invention in a radio telephone. The structure illustrated by this example combines a radio telephone antenna and speaker. The antenna comprises on the upper surface of a telephone circuit board 205 a conductive ground plane GND and, parallel therewith, a radiating plane 210. Connected to the radiating plane is an antenna feed conductor 221. The radiating plane is also connected to the ground via a short-circuit conductor 222 so that the antenna is a planar inverted F antenna (PIFA). In order to produce two operation bands the radiating plane includes a slot 215 which divides the radiating plane into two branches of different lengths, as viewed from the short-circuit point. A first branch 211 lies in the center region of the radiating plane and a second branch 212 follows the edges of the plane around the first branch and ends close to the feed point of the antenna.

For the speaker function the structure shown in FIG. 2a comprises a piezoelectric element 250. This is attached by gluing or sintering, for example, to the upper surface of the radiating plane 210, within the first branch 211. Viewed from above, the element 250 is an oblong rectangle, and its longitudinal direction is the same as that of the strip formed by the first branch. The upper and lower surfaces of the piezoelectric element are conductive. The upper surface is connected to an audio amplifier output in the radio telephone via an audio conductor 251 and the lower surface via a second audio conductor 252. The second audio conductor may also be the radiating plane 210. The piezoelectric element 250 can thus be driven by audio signals of the telephone.

FIG. 2b illustrates the principle of the speaker function. There is shown in a lateral view a piezoelectric element 250 and the first branch 211 of the radiating plane. The radiating plane is attached through a rigid supportive element 280 to the circuit board beneath it at that end of the piezoelectric element which is farther away from the free end of the first branch. As the piezoelectric element is driven by an alternative voltage, its length l tends to change in accordance with the voltage. The attachment of the element to the radiating plane prevents the length of the element from changing freely. Therefore the element bends the strip formed by the first branch 211 down when the polarity of the driving voltage tends to cause lengthening in the element, and up when the polarity of the driving voltage tends to cause shortening in the element. These bending directions stem from the fact that the piezoelectric element is located on the upper surface of the plane. If it were located on the lower surface, the bending directions would be the reverse. In FIG. 2b the free end of the first branch of the radiating plane vibrates at a magnitude m, which depends of the amplitude of the driving voltage. The first branch thus generates in the surrounding air pressure variation according to the audio signal variation. The plane that emits radio waves thus also emits sound waves. Acceptable sound reproduction usually requires that acoustic short-circuit is prevented. To that end there is an almost closed frame between the radiating plane and the ground plane, of which frame FIG. 2a shows a portion 240. In addition, the slot 215 in the radiating plane is covered by a flexible dielectric film.

The structure of FIGS. 2a and 2b may also be applied inverted so that it serves as a microphone. In that case the periodic moving of the planar element 211 is caused by sound waves coming from outside. The piezoelectric element 250 then generates an electric signal corresponding to the sound waves.

In this description and in the claims the prefixes “upper” and “lower” as well as the words “up” and “down” refer to the orientation of the structures shown in the drawings described, and they are in no way connected to the operating positions of the devices.

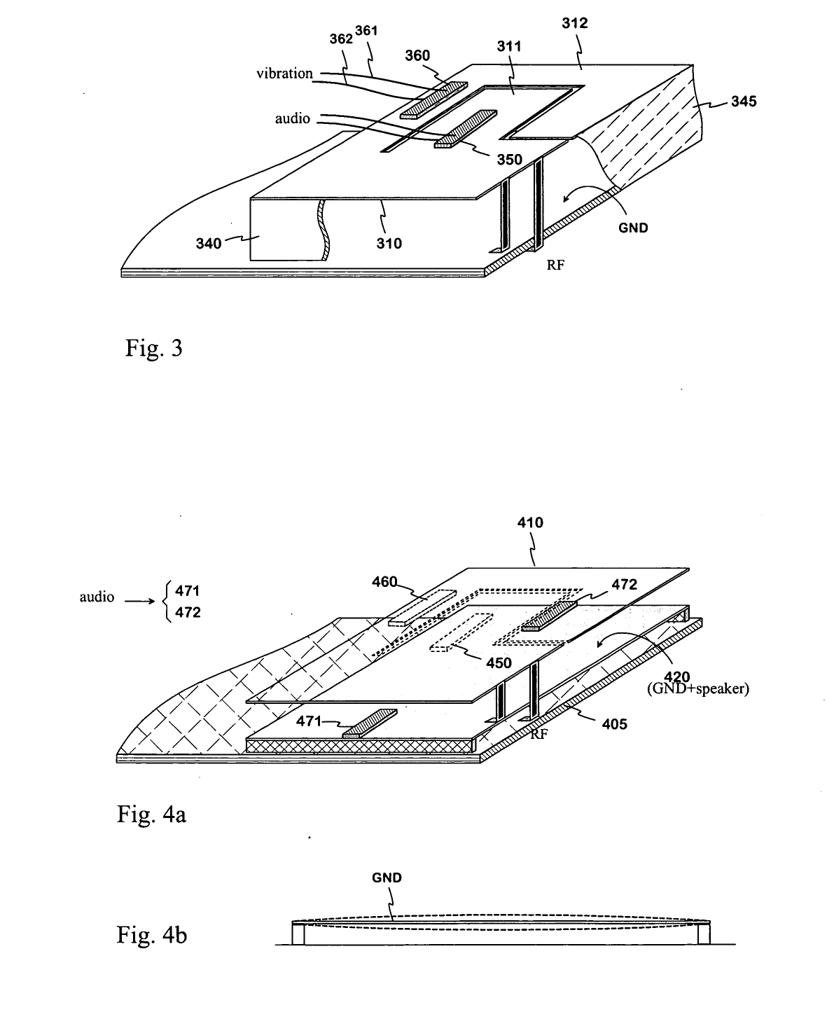

FIG. 3 shows a second example of integration according to the invention in a radio telephone. The structure illustrated by this example combines a radio telephone antenna, speaker, and a vibrator. The basic structure is like that described in FIG. 2. Also the speaker arrangement implemented using a first piezoelectric element 350 is identical to that of FIG. 2. In FIG. 3 there is additionally a second piezoelectric element 360 attached to the second branch 312 of the radiating plane 310, relatively close to the point where the first branch and second branch become separated. In its longitudinal direction the second element 360 is parallel to the center line of the second branch. Its upper surface is connected to a vibration oscillator output in the radio telephone via a vibration conductor 361, and the lower surface via a second vibration conductor 362. As in FIG. 2b, the radiating plane is rigidly attached to a circuit board beneath it at that end of the second piezoelectric element which is closer to the beginning of the second branch. Thus when a ringing signal arrives at the second piezoelectric element, the second branch 312, from said attachment point to the free end, vibrates according to the ringing voltage variation. To enable vibration of the second branch, the frame 340 between the radiating plane 310 and ground plane, following the outer edge of the radiating plane, is not rigid, at least for the length of the second branch. In FIG. 3 this flexible portion of the frame is denoted by reference number 345.

FIG. 4a shows a fourth example of integration according to the invention in a radio telephone. The structure illustrated by this example combines a radio telephone antenna, at least one speaker, and a vibrator. The basic structure differs from the structure depicted in FIG. 2 in that the antenna ground plane 420 is now a separate conductive plane between the radio telephone circuit board 405 and the radiating plane 410. The ground plane is rigidly attached by its opposing ends to the circuit board. Approximately at the middle of the both supported ends of the ground plane there is attached a piezoelectric element, a first end element 471, and a second end element 472. In their longitudinal direction these elements point to the opposite end of the ground plane. Electrically they are connected in parallel, and their driving voltages come from an audio amplifier in the telephone. Thus when the audio voltage tends to lengthen the end elements, both of these force the ground plane to arch upwards, and when the audio voltage tends to shorten the end elements, both of them force the ground plane to arch downwards. The ground plane vibrates, as shown in FIG. 4b, according to the sound signal and the amplitude of its variation.

The plane 410 that emits radio waves is drawn transparent in FIG. 4a in order to completely show the ground plane beneath it and its end elements. On the radiating plane, too, may be piezoelectric elements. Broken lines depict elements 450 and 460 located like elements 350 and 360 in FIG. 3. The former can be used to realize a speaker, for example, and the latter a vibrator. There would be two speakers in this case, because the ground plane would serve as a speaker, too, as described above. The speakers can be designed to operate at different volume levels and, correspondingly, for different uses.

Above it was described structures according to the invention. The invention is not limited to those structures. The number of piezoelectric elements may vary from an application to another. Instead of or in addition to the upper surface of the radiating plane they can also be attached to the lower surface thereof, for example. The inventional idea can be applied in different ways within the scope defined by the independent claim 1.

1. An integrated radio telephone structure, which radio telephone comprises an audio amplifier and at least one planar element for both a first and a second function, said planar element belonging to an antenna in the radio telephone and the second function being periodic moving of said planar element, for which the structure comprises a piezoelectric element attached to said planar element.

2. A structure according to claim 1, said piezoelectric element being coupled to an audio amplifier output, whereby said periodic moving of the planar element is generation of sound.

3. A structure according to claim 2, where a radiating plane of said antenna has a first branch and a second branch to produce two bands, said planar element being the first branch of the radiating plane.

4. A structure according to claim 3, further comprising a second piezoelectric element which is attached to the second branch of the radiating plane.

5. A structure according to claim 1, where said antenna comprises a separate ground plane, said planar element being the ground plane.

6. A structure according to claim 5, said piezoelectric element being attached to the ground plane at a first fixedly-supported end thereof, and the structure further comprises a second piezoelectric element which is attached to the ground plane at a second fixedly-supported end thereof.

7. A structure according to claim 1, in which the radio telephone comprises a vibration oscillator, a piezoelectric element being coupled to the vibration oscillator, whereby said periodic moving of the planar element is generation of alarm vibration.

8. A structure according to claim 7, where a radiating plane of said antenna has a first branch and a second branch to produce two bands, and the structure comprises a first and a second piezoelectric element, the first piezoelectric element being attached to the first branch of the radiating plane and said piezoelectric element coupled to the vibration oscillator being the second piezoelectric element, which is attached to the second branch of the radiating plane.

9. A structure according to claim 1, said periodic moving of the planar element being caused by sound waves coming from outside, whereby the aim of said piezoelectric element is to generate an electric signal corresponding to the sound waves.

10. A structure according to claim 1, said piezoelectric element being made of a ceramic material.
